(19) United States
(12) Patent Application Publication
(10) Pub. No.: US 2011/0291431 A1
(43) Pub. Date: Dec. 1, 2011

(54) CRASH BOX, AND METHOD OF MAKING A CRASH BOX

(75) Inventors: Otto Buschsieweke, Paderborn (DE); Markus Kettler, Paderborn (DE); Martin Schroeter, Paderborn (DE)

(73) Assignee: Benteler Automobiltechnik GmbH, Paderborn (DE)

(21) Appl. No.: 12/958,537

(22) Filed: Dec. 2, 2010

(30) Foreign Application Priority Data
Dec. 2, 2009 (DE) 10 2009 056 443.8

(51) Int. Cl. B60R 19/34; B05D 3/02; C21D 8/02

(52) U.S. Cl. 293/133; 148/653; 148/537

(57) ABSTRACT

A crash box for installation between a bumper crossbeam and a side rail of a motor vehicle is made from a longitudinal beam made of a steel alloy having the following composition in weight-%, 0.15 to 0.30% of carbon (C), 0.10 to 0.70% of silicon (Si), 1.00 to 2.50% of manganese (Mn), 0.10 to 0.50% of chromium (Cr), 0.02 to 0.05% of titanium (Ti), 0.001 to 0.005% of boron (B), 0.01 to 0.06% of aluminum (Al), up to 0.50% of molybdenum (Mo), max. 0.025% of phosphorus (P), max. 0.015% of sulfur (S), remainder iron (Fe) including impurities resulting from smelting. The longitudinal beam is hot-formed and press-hardened and then heat-treated at a temperature of 200° C. to 800° C., with a material of the longitudinal beam having a bend angle of greater than or equal to 60° after heat treatment and measured in accordance with DIN EN ISO 7438.

### CROSS-REFERENCES TO RELATED APPLICATIONS

This application claims the priority of German Patent Application, Serial No. 10 2009 056 443.8, filed Dec. 2, 2009, pursuant to 35 U.S.C. 119(a)-(d), the content of which is incorporated herein by reference in its entirety as if fully set forth herein.

### BACKGROUND OF THE INVENTION

The present invention relates to a crash box for installation between a bumper crossbeam and a side rail of a motor vehicle, and to a method of making such a crash box.

The following discussion of related art is provided to assist the reader in understanding the advantages of the invention, and is not to be construed as an admission that this related art is prior art to this invention.

Bumper systems are used to primarily absorb impact forces in the event of a collision and to protect the vehicle body in the event of an impact at low speed against structural damage. In addition, a bumper is also useful in the protection of pedestrians when colliding with a motor vehicle. A bumper typically includes a rigid bumper crossbeam installed across the front and rear of the vehicle and connected to left and right side rails via crash boxes, respectively. Energy generated in the event of impact is introduced via the bumper crossbeam into the crash boxes which convert the impact energy into deformation work. As a result, damage and the amount of damage can be significantly reduced.

It would be desirable and advantageous to provide an improved crash box to obviate prior art shortcomings.

### SUMMARY OF THE INVENTION

According to one aspect of the present invention, a crash box for installation between a bumper crossbeam and a side rail of a motor vehicle includes a longitudinal beam made of a steel alloy having the following composition in weight-%:0.15 to 0.30% of carbon (C), 0.10 to 0.70% of silicon (Si), 1.00 to 2.50% of manganese (Mn), 0.10 to 0.50% of chromium (Cr), 0.02 to 0.025% of titanium (Ti), 0.001 to 0.005% of boron (B), 0.01 to 0.06% of aluminum (Al), up to 0.50% of molybdenum (Mo), max. 0.025% of phosphorus (P), max. 0.015% of sulfur (S), remainder iron (Fe) including impurities resulting from smelting, wherein the longitudinal beam is hot-formed and press-hardened and then heat-treated at a temperature of 200° C. to 800° C., with a material of the longitudinal beam having a bend angle of greater than or equal to 60° after heat treatment and measured in accordance with DIN EN ISO 7438.

According to another aspect of the present invention, a method of manufacturing a crash box includes the steps of making a steel sheet from steel alloy having a composition containing in weight-%:0.15 to 0.30° AD of carbon (0), 0.10 to 0.70% of silicon (Si), 1.00 to 2.50% of manganese (Mn), 0.10 to 0.50% of chromium (Cr), 0.02 to 0.025% of titanium (Ti), 0.001 to 0.005% of boron (B), 0.01 to 0.06% of aluminum (Al), up to 0.50% of molybdenum (Mo), max. 0.025% of phosphorus (P), max. 0.015% of sulfur (S), remainder iron (Fe) including impurities resulting from smelting, hot-forming the steel sheet, press-hardening the steel sheet, and heat-treating the steel sheet at a temperature of 200° C. to 800° C. for production of a longitudinal beam of a material having a bend angle of greater than or equal to 60° after heat treatment and measured in accordance with DIN EN ISO 7438.

The referred-to standard DIN EN ISO 7438 represents an international standard which is entitled “Metallic Materials-Bend Test” and establishes a method for determining the ability of metallic materials to undergo plastic deformability in bending. The equivalent U.S. standard is ASTM E290-09 “Standard Test Methods for Bend Testing of Material for Ductility”.

The present invention resolves prior art shortcomings by using a steel sheet of hardenable manganese-boron steel alloy for manufacturing the longitudinal beam of the crash box. The longitudinal beam is hot-formed and press-hardened. Thereafter, the longitudinal beam is heat-treated in a targeted manner at least in some areas. Heat treatment is carried out by controlling temperature and time in order to attain the wanted bend angle of greater than or equal to 60°, in particular 60° to 80°. Currently preferred is a bend angle of 65° to 78°. The steel alloy according to the present invention can be hot-formed as well as quenched and tempered and exhibits high mechanical values. Compared to conventional crash boxes of same weight, a crash box according to the present invention has better energy absorption capability, or a lower weight, when same efficiency is involved.

According to another advantageous feature of the present invention, the proportion of molybdenum in the composition may be 0.01% to 0.025% by weight, although, the steel allow may also be free of molybdenum altogether.

According to another advantageous feature of the present invention, the longitudinal beam can be heat-treated at a temperature between 200° C. to 600° C., or between 300° C. to 500° C. Currently preferred is a heat treatment of the longitudinal beam at a temperature between 350° C. to 500° C. The heat treatment can be carried out over a time period of 30 minutes to 240 minutes, or 45 minutes to 200 minutes. Currently preferred is a time period for the heat treatment of 60 minutes to 150 minutes. The desired properties of the components can be adjusted through suitable temperature and time controls, with both parameters being best suited to one another.

According to another advantageous feature of the present invention, the material of the longitudinal beam can have a bend angle of 60° to 120° after heat treatment and measured in accordance with DIN EN ISO 7438. Currently preferred is a bend angle of 60° to 80° after heat treatment and measured in accordance with DIN EN ISO 7438. The improved material properties of the longitudinal beam can be demonstrated by the so-called plate bend test according to DIN EN ISO 7438, which involves a bending of a material sample by a sharp radius. The tests have shown that cracking of the material is much delayed, i.e. when the bend angle is great. The test setup can be described as follows:
DIN EN ISO 7438, section 4.2 (bending device with contact rollers and a bending plunger)
distance of contact rollers: I=2*a+0.5 mm=4.50 mm
diameter of contact rollers: 30 mm
diameter of bending ram: D=0.8 mm
sample wall thickness: a=2.0 mm
sample dimensions: L=60 mm×60 mm.

By following the press-hardening step with a heat-treatment step, hardening strain can be reduced without adversely affecting hardness. At the same time, brittleness of the hardening structure is alleviated and toughness enhanced. Tensile strength Rₘ is lowered from about 1,500 MPa to about 1,200 MPa. The yield point Rₚ 0.2 of the steel material is then at about 1,150 MPa and the percentage elongation A₅ after fracture is about 8%. A feature of a crash box according to the present invention is the increase of the bend angle of the material through heat treatment to about 60° to 120° or to a currently preferred bend angle between 60° and 80°. As a result, the crumpling behavior of a crash box according to the present invention is positively affected and an even energy absorption is attained during plastic deformation in the event of an impact. Moreover, the mechanical properties lead to significant weight savings.

The subsequent tempering process with a heat treatment in the desired temperature range over the desired time period ensures that the material exhibits a required ductility while still having a high strength so as to attain adequate crumpling in the absence of a fracture. Heat treatment may involve for example induction heating or may be carried out in an electrically heated batch furnace. The use of high-strength steel material allows a decrease in the wall thickness of the crash box, leading to the improved weight benefit. As described above, compared to conventional crash boxes of same weight, a crash box according to the present invention has better energy absorption capability, or a lower weight, when same efficiency is involved. Apart from the lesser overall weight, a crash box according to the present invention can also be made of lesser overall length.

According to another advantageous feature of the present invention, the longitudinal beam can be made of two U-shaped shell bodies. The shell bodies may be hot-formed and press-hardened and subjected to the heat treatment in the desired temperature range before being joined to form the longitudinal beam. It is also conceivable to heat-treat the finished longitudinal beam to provide it with the desired material properties.

According to another advantageous feature of the present invention, the longitudinal beam may have varying wall thickness. The wall thickness of the longitudinal beam may hereby vary in length direction of the longitudinal beam as well as circumferential direction.

According to another advantageous feature of the present invention, the longitudinal beam may have profiled sidewalls, e.g. with embossments, dents, protrusions, or holes. The longitudinal beam may have an initial deformation spot which triggers a plastic deformation of the longitudinal beam with even crumpling in the event of an impact which exceeds a permissible limit value.

The longitudinal beam may in principle have different cross sectional geometries. Currently preferred is a cross sectional geometry of the longitudinal beam in the form of a truncated pyramid. The cross section increases hereby from the bumper-beam proximate end of the longitudinal beam to the side-rail-proximate end of the longitudinal beam.

According to another advantageous feature of the present invention, a mounting plate may be provided on a side-rail-proximal end of the longitudinal beam. The longitudinal beam and the mounting plate may have different wall thicknesses. For example, the mounting plate may have a wall thickness which is greater than the wall thickness of the longitudinal beam. The mounting plate may be connected in one piece with the longitudinal beam. It is also conceivable to jointly form the mounting plate and the longitudinal beam. When the longitudinal beam is made of two shell bodies, mounting plate portions may be formed during the shaping process on the shell body.

The crash box and its components, in particular the longitudinal beam, may be provided with a coating, in particular an anticorrosive coating of aluminum/silicon or zinc, for example. The longitudinal beam or the components used to manufacture the longitudinal beam as well as other components of the crash box may be provided before or after heat treatment with a coating, e.g. a metallic coating.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective view of a bumper having incorporated therein a crash box according to the present invention; and

FIG. 2 is a perspective view of a crash box according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

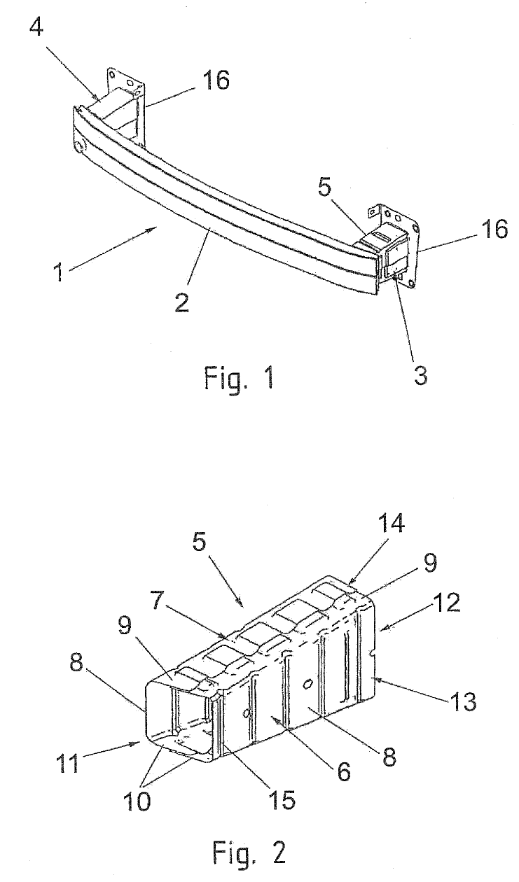

Turning now to the drawing, and in particular to FIG. 1, there is shown a perspective view of a bumper, generally designated by reference numeral 1 and provided for the front and rear zones that is lined by a cover of a body of a motor vehicle.

The bumper 1 includes a bumper crossbeam 2 arranged transversely to unillustrated side rails of the motor vehicle, and crash boxes 3, 4 which are installed between the bumper crossbeam 2 and the side rails. In the event of a frontal collision at low speed as typically encountered in a rear-end accident within city limits, the crash boxes 3, 4 absorb the impact energy through plastic deformation and convert the impact energy in deformation work. The bumper 1 also protects pedestrians and reduces the risk of injury in the event of a collision with the motor vehicle.

The bumper crossbeam 2 is preferably made of a sheet metal, e.g. a hot-formed and press-hardened high-strength steel sheet.

FIG. 2 shows an exemplary crash box 3, 4 which includes a longitudinal beam 5 made by way of shell construction of two shell bodies 6, 7. The shell bodies 6, 7 have a U shaped configuration with a wall 8 and two legs 9, 10 interconnected by the wall 8. The shell bodies 6, 7 have complementary configuration and overlap with the ends of their legs 9, 10. In the overlap zone, the legs 9, 10 are joined, e.g. by a rolling weld seam.

The longitudinal beam 5 or the shell bodies 6, 7 are hot-formed from a steel sheet and clamped in a shaping tool and press-hardened. The steel sheet is hereby heated to a temperature above the AC₃ point, typically to a temperature between 900° C. and 980° C., transferred to the shaping tool, and hot-formed there and tempered and hardened through cool down.

An example of a material for the longitudinal beam 5 or the shell bodies 6, 7 involves a steel alloy which includes, in weight-%, 0.15 to 0.30% of carbon (C), 0.10 to 0.70% of silicon (Si), 1.00 to 2.50% of manganese (Mn), 0.10 to 0.50% of chromium (Cr), 0.02 to 0.025% of titanium (Ti), 0.001 to 0.005% of boron (B), 0.01 to 0.06% of aluminum (Al), up to 0.50% of molybdenum (Mo), maximal 0.025% of phosphorus (P), maximal 0.015% of sulfur (S), remainder iron (Fe) including impurities resulting from smelting.

After hot-forming and press-hardening, the longitudinal beam 5 or the shell bodies 6, 7 are subjected to a heat treatment at a temperature between 200° C. to 600° C., preferably between 300° C. to 500° C. Currently preferred is a heat treatment of the longitudinal beam 5 at a temperature between 350° C. to 500° C. The heat treatment can be carried out over a time period of 45 minutes to 90 minutes, for example. The heat treatment is tailored in such a way that the material of the longitudinal beam 5 after heat treatment has a bend angle, as measured according to DIN EN ISO 7438, of 60° to 120°, in particular between 60° to 80°. The bend angle may also be measured according to U.S. standard ASTM E290-09. Material properties can be adjusted by controlling temperature and time of the heat treatment.

By following press hardening with the heat treatment, the tensile strength decreases compared to an untreated component, while the yield point remains approximately the same. Still, the material exhibits the high-strength mechanical properties with sufficiently high strengths as demanded for the proper function of the crash box. As a result of the heat treatment after press-hardening, the ductility of the material increases so that the crash box 3, 4 plastically deforms that it crumples when exposed to a load, and absorbs energy without breaking or rupturing.

Basically, it should be noted that the longitudinal beam 5 may undergo in its entirety the heat treatment after being press-hardened. When the longitudinal beam 5 is composed of the shell bodies 6, 7, the shell bodies 6, 7 are suitable hot-formed, press-hardened, and then heat-treated. Thereafter, the shell bodies 6, 7 are joined together to form the longitudinal beam 5.

The longitudinal beam 5 has a cross section in the form of a truncated pyramid, with the cross section increasing from the bumper-beam-proximal end 11 to the side-rail-proximate end 12.

The walls 8 and the legs 9, 10 of the shell bodies 6, 7 form the sidewalls 13, 14 of the longitudinal beam 5. The sidewalls 13, 14 are profiled, e.g. through formation of embossments, holes, or dents. Suitably, the longitudinal beam 5 is formed with an initial deformation spot 15.

As can be seen from FIG. 1, a mounting plate 16 is arranged on the side-rail-proximate end 12 of each crash box 3, 4, for securement of the bumper 1 to the side rails of the motor vehicle.

The longitudinal beam 5 and the mounting plate 16 may have varying wall thicknesses. The mounting plate 16 may be a separate component or may be designed in one piece with the side-rail-proximate end 12 of the longitudinal beam 5.

Advantageously, the crash box 3, 4 and in particular the longitudinal beam 5 may be provided with a coating, e.g. metallic coating on aluminum/silicon basis or zinc basis. Of course, any suitable anticorrosive coating may be applied upon the crash box 3, 4 and its components.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A crash box for installation between a bumper crossbeam and a side rail of a motor vehicle, said crash box having a longitudinal beam made of a steel alloy having the following composition in weight-%:

| | |
|---|---|
| Carbon (C) | 0.15 to 0.30% |
| Silicon (Si) | 0.10 to 0.70% |
| Manganese (Mn) | 1.00 to 2.50% |
| Chromium (Cr) | 0.10 to 0.50% |
| Titanium (Ti) | 0.02 to 0.05% |
| Boron (B) | 0.001 to 0.005% |
| Aluminum (Al) | 0.01 to 0.06% |
| Molybdenum (Mo) | up to 0.50% |
| Phosphorus (P) | max. 0.025% |
| Sulfur (S) | max. 0.015% |

remainder iron (Fe) including impurities resulting from smelting,
wherein the longitudinal beam is hot-formed and press-hardened and then heat-treated at a temperature of 200° C. to 800° C., with a material of the longitudinal beam having a bend angle of greater than or equal to 60° after heat treatment and measured in accordance with DIN EN ISO 7438.

2. The crash box of claim 1, wherein a proportion of molybdenum is 0.01% to 0.025% by weight.

3. The crash box of claim 1, wherein the longitudinal beam is heat-treated at a temperature between 200° C. to 600° C.

4. The crash box of claim 1, wherein the longitudinal beam is heat-treated at a temperature between 300° C. to 500° C.

5. The crash box of claim 1, wherein the longitudinal beam is heat-treated at a temperature between 350° C. to 500° C.

6. The crash box of claim 1, wherein the material of the longitudinal beam has a bend angle of greater than or equal to 60° to 120° after heat treatment and measured in accordance with DIN EN ISO 7438.

7. The crash box of claim 1, wherein the material of the longitudinal beam has a bend angle of 60° to 80° after heat treatment and measured in accordance with DIN EN ISO 7438.

8. The crash box of claim 1, wherein the material of the longitudinal beam has a bend angle of 65° to 78° after heat treatment and measured in accordance with DIN EN ISO 7438.

9. The crash box of claim 1, wherein the longitudinal beam is made of two U-shaped shell bodies.

10. The crash box of claim 1, wherein the longitudinal beam has varying wall thickness.

11. The crash box of claim 1, wherein the longitudinal beam has a shape in the form of a truncated pyramid.

12. The crash box of claim 1, wherein the longitudinal beam has profiled sidewalls.

13. The crash box of claim 1, wherein the longitudinal beam has an initial deformation spot.

14. The crash box of claim 1, further comprising a mounting plate provided on a side-rail-proximal end of the longitudinal beam.

15. The crash box of claim 14, wherein the longitudinal beam and the mounting plate have different wall thicknesses.

16. The crash box of claim 14, wherein the mounting plate is connected in one piece with the longitudinal beam.

17. The crash box of claim 1, wherein the longitudinal beam has a coated surface.

18. A method of manufacturing a crash box, comprising the steps of:
making a steel sheet from steel alloy having a composition containing in weight-%:

| | |
|---|---|
| Carbon (C) | 0.15 to 0.30% |
| Silicon (Si) | 0.10 to 0.70% |
| Manganese (Mn) | 1.00 to 2.50% |
| Chromium (Cr) | 0.10 to 0.50% |
| Titanium (Ti) | 0.02 to 0.05% |
| Boron (B) | 0.001 to 0.005% |
| Aluminum (Al) | 0.01 to 0.06% |
| Molybdenum (Mo) | up to 0.50% |
| Phosphorus (P) | max. 0.025% |
| Sulfur (S) | max. 0.015% |

remainder iron (Fe) including impurities resulting from smelting;
hot forming the steel sheet;
press hardening the steel sheet; and
heat treating the steel sheet at a temperature of 200° C. to 800° C. for production of a longitudinal beam having a bend angle of greater than or equal to 60° after heat treatment and measured in accordance with DIN EN ISO 7438.

19. The method of claim 18, wherein the bend angle is 60° to 80°.

20. The method of claim 18, wherein the heat treating step is executed at a temperature between 200° C. to 600° C.

21. The method of claim 18, wherein the heat treating step is executed at a temperature between 300° C. to 500° C.

22. The method of claim 18, wherein the heat treating step is executed at a temperature between 350° C. to 500° C.

23. The method of claim 18, wherein the heat treating step is executed over a time period of 30 min to 240 min.

24. The method of claim 18, wherein the heat treating step is executed over a time period of 45 min to 200 min.

25. The method of claim 18, wherein the heat treating step is executed over a time period of 60 min to 150 min.

26. The method of claim 18, further comprising the step of producing the longitudinal beam by joining two U-shaped shell bodies.

27. The method of claim 26, further comprising the step of subjecting the shell bodies to a heat treatment before joining them to form the longitudinal beam.

28. The method of claim 26, wherein the longitudinal beam formed from the shell bodies undergoes the heat-treating step.

29. The method of claim 18, further comprising the step of coating a surface of the longitudinal beam before or after the heat treating step.

30. The method of claim 26, further comprising the step of coating a surface of the shell bodies before or after the heat treatment.
